(19) United States
(12) Patent Application Publication
(10) Pub. No.: US 2008/0012798 A1
(43) Pub. Date: Jan. 17, 2008

(54) PLASMA DISPLAY APPARATUS AND DRIVING METHOD OF PLASMA DISPLAY PANEL

(75) Inventors: Kyung Ryeol Shim, Gumi-si (KR); Jong Hak Lee, Pohang-si (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 11/619,221

(22) Filed: Jan. 3, 2007

(30) Foreign Application Priority Data
Jul. 12, 2006 (KR) 10-2006-0065512

(51) Int. Cl. G09G 3/28

(52) U.S. Cl. 345/68

(57) ABSTRACT

Provided is a plasma display apparatus. The apparatus includes a plasma display panel having a plurality of scan electrode lines and address electrode lines, and supplying a scan signal to the scan electrode lines and supplying an address signal to the address electrode lines. The apparatus includes an inductor forming a resonance circuit together with a capacitance of the panel. Whereby the address signal comprises a gradual rise or fall period. A supply start time point of the address signal precedes a supply start time point of the scan signal.

This Nonprovisional application claims priority under 35 U.S.C. § 119(a) on Patent Application No. 10-2006-0065512 filed in Korea on Jul. 12, 2006, the entire contents of which are hereby incorporated by reference.

### BACKGROUND OF THE INVENTION

1. Field of the Invention

The present invention relates to a device for driving a plasma display panel, and more particularly, to an address driving device of a plasma display panel, for enabling high-speed addressing and reducing power consumption.

2. Description of the Background Art

In a plasma display panel, a barrier rib formed between an upper substrate and a lower substrate forms one unitary cell. Main discharge gas such as neon (Ne), helium (He) or a mixture (He+Ne) of neon and helium and inert gas containing a small amount of xenon (Xe) are filled in each cell. When a discharge is induced using a high frequency voltage, the inert gas generates vacuum ultraviolet rays and excites phosphors provided between the barrier ribs, thereby realizing an image. The plasma display panel is attracting attention as a next generation display apparatus due to its slimming and lightweighting.

In general, the plasma display panel is time-division driven by dividing a unit frame displaying an image into a plurality of subfields. Each of the subfields is divided into a reset period for initializing an entire discharge cell, an address period for distinguishing the entire discharge cell into on cells and off cells, and a sustain period for performing a sustain discharge depending on a gray level weight allocated at each subfield in the discharge cell selected as the on cell.

During the address period, a negative scan voltage and a positive address voltage are supplied to a scan electrode and an address electrode of the turn-on cell, respectively, depending on data to be displayed, thereby selecting the discharge cell by the address discharge generated by a difference between two voltages.

In case where the address signal is supplied to the address electrode, it takes a time of about several hundreds of ns (nano seconds) to several μs (micro seconds) until a discharge is induced from a supply time point of the address signal. This phenomenon is called a discharge time lag. Depending on the discharge time lag, a time required for addressing increases, thereby reducing a jitter level and not sufficiently guaranteeing a driving margin of the panel.

### SUMMARY OF THE INVENTION

Accordingly, the present invention is to solve at least the problems and disadvantages of the background art.

The present invention is to provide a plasma display apparatus for reducing a time required for addressing, thereby sufficiently guaranteeing a driving margin of a plasma display panel suitable even to single scan driving, in driving the panel provided for the plasma display apparatus.

To achieve these and other advantages and in accordance with the purpose of the present invention, as embodied and broadly described, there is provided a plasma display apparatus including a plasma display panel having a plurality of scan electrode lines and address electrode lines, and supplying a scan signal to the scan electrode lines and supplying an address signal to the address electrode lines. The apparatus includes an inductor forming a resonance circuit together with a capacitance of the panel. Whereby the address signal comprises a gradual rise or fall period. A supply start time point of the address signal precedes a supply start time point of the scan signal.

In another aspect, there is provided a plasma display apparatus including a plasma display panel having a plurality of scan electrode lines and address electrode lines, and supplying a scan signal to the scan electrode lines and supplying an address signal to the address electrode lines. The apparatus includes a scan driver and an address driver. The scan driver includes a scan-up switch turning on to supply the scan signal having a scan voltage to the scan electrode line, and a scan-down switch turning on to terminate a supply of the scan signal. The address driver includes a source capacitor for storing energy recovered from the address electrode, a first switch turning on to supply the energy stored in the source capacitor to the address electrode, an inductor forming a resonance circuit together with a capacitance of the panel, and a second switch turning on to recover the energy from the address electrode. The address signal includes a gradual rise or fall period. The first switch turns on earlier than the scan-up switch in an address period.

### BRIEF DESCRIPTION OF THE DRAWINGS

The invention will be described in detail with reference to the following drawings in which like numerals refer to like elements.

FIG. 1 is a perspective diagram illustrating a structure of a plasma display panel according to an exemplary embodiment of the present invention;

FIG. 2 is a diagram illustrating an electrode of a plasma display panel according to an exemplary embodiment of the present invention;

FIG. 3 is a timing diagram illustrating a method for time-division driving a plasma display panel by dividing one frame into a plurality of subfields;

FIG. 4 is a timing diagram illustrating driving signals for driving a plasma display panel according to an exemplary embodiment of the present invention;

FIG. 5 is a circuit diagram illustrating a construction of an address driving circuit according to an exemplary embodiment of the present invention;

FIG. 6 is a circuit diagram illustrating a construction of a scan driving circuit according to an exemplary embodiment of the present invention;

FIG. 7 is a diagram illustrating a discharge current depending on a discharge time lag occurring after an address signal is supplied; and

FIG. 8 is a timing diagram illustrating time points for supplying a scan signal and an address signal according to the present invention.

### DETAILED DESCRIPTION OF PREFERRED EMBODIMENTS

Preferred embodiments of the present invention will be described in a more detailed manner with reference to the drawings.

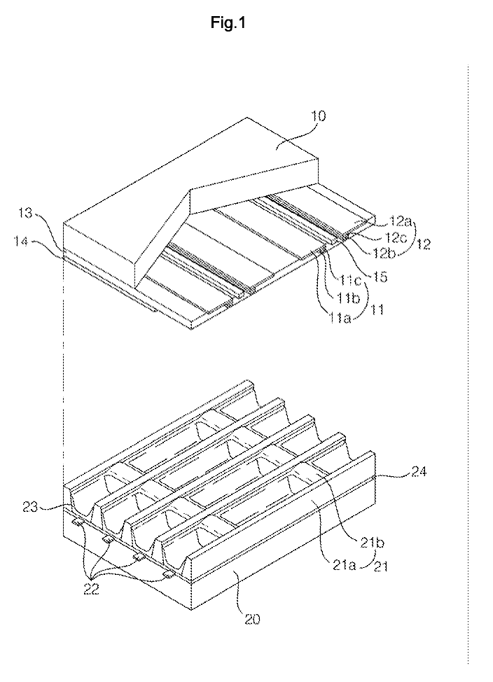

FIG. 1 is a perspective diagram illustrating a structure of a plasma display panel according to an exemplary embodiment of the present invention.

As shown in FIG. 1, the plasma display panel includes a scan electrode 11 and a sustain electrode 12 that constitute a sustain electrode pair formed on an upper substrate 10; and an address electrode 22 formed on a lower substrate 20.

The sustain electrode pair 11 and 12 includes transparent electrodes 11a and 12a, and bus electrodes 11b and 12b. The transparent electrodes 11a and 12a are formed of Indium-Tin-Oxide (ITO). The bus electrodes 11b and 12b can be formed of metal such as silver (Ag) and chrome (Cr). Alternately, the bus electrodes 11b and 12b can be of laminate type based on chrome/copper/chrome (Cr/Cu/Cr) or chrome/aluminum/chrome (Cr/Al/Cr). The bus electrodes 11b and 12b are formed on the transparent electrodes 11a and 12a, and reduce a voltage drop caused by the transparent electrodes 11a and 12a having high resistances.

In an exemplary embodiment of the present invention, the sustain electrode pair 11 and 12 can be of structure in which the transparent electrodes 11a and 12a and the bus electrodes 11b and 12b are laminated, as well as can be of structure based on only the bus electrodes 11b and 12b, excluding the transparent electrodes 11a and 12a. This structure is advantageous of reducing a panel manufacture cost because it does not use the transparent electrodes 11a and 12a. The bus electrodes 11b and 12b used for this structure can be formed of diverse materials such as photosensitive material in addition to the above-described materials.

A Black Matrix (BM) 15 is provided between the transparent electrodes 11a and 12a and the bus electrodes 11b and 12b (11c→12b) of the scan electrode 11 and the sustain electrode 12. The black matrix 15 performs a light shield function of absorbing external light emitting from an outside of the upper substrate 10 and reducing reflection, and a function of improving purity and contrast of the upper substrate 10.

In an exemplary embodiment of the present invention, the black matrix 15 is formed on the upper substrate 10. The black matrix 15 can be comprised of a first black matrix 15, and second black matrixes 11c and 12c. The first black matrix 15 is formed in a position where it overlaps with a barrier rib 21. The second black matrixes 11c and 12c are formed between the transparent electrodes 11a and 12a and the bus electrodes 11b and 12b. The first black matrix 15, and the second black matrixes 11c and 12c (called black layers or black electrode layers) can be concurrently formed in their forming processes, physically connecting with each other. Alternately, the first black matrix 15 and the second black matrixes 11c and 12c are not concurrently formed, physically disconnecting with each other.

The black matrix can be concurrently formed together with the above-described black layers in its forming process, physically connecting with each other. Alternately, the black matrix can be formed at a different time point, physically disconnecting from each other. The black matrix and the black layer are formed of same material in case where they physically connect with each other. However, the black matrix and the black layer are formed of different materials in case where they physically disconnect from each other.

An upper dielectric layer 13 and a protective film 14 are layered on the upper substrate 10 where the scan electrode 11 and the sustain electrode 12 are formed in parallel with each other. Charged particles generated by discharge are accumulated on the upper dielectric layer 13. The upper dielectric layer 13 can protect the sustain electrode pair 11 and 12. The protective film 14 protects the upper dielectric layer 13 against sputtering of the charged particles generated by the gas discharge. The protective film 14 enhances an efficiency of emitting secondary electrons.

The scan electrode 11 and the sustain electrode 12 can be formed on a predetermined black layer without directly contacting with the upper substrate 10 though it is not illustrated in FIG. 1. In other words, the black layer can be formed between the upper substrate 10 and the scan electrode 11 and the sustain electrode 12, thereby preventing the upper substrate 10 from being discolored because of the direct contact between the upper substrate 10 and the scan electrode 11 and the sustain electrode 12.

The address electrode 22 is formed in the direction of intersecting with the scan electrode 11 and the sustain electrode 12. A lower dielectric layer 24 and the barrier rib 21 are formed on the lower substrate 20 including the address electrode 22.

A phosphor layer 23 is formed on surfaces of the lower dielectric layer 24 and the barrier rib 21. The barrier rib 21 includes a vertical barrier rib 21a and a horizontal barrier rib 21b that are formed in a closed type. The barrier rib 21 physically distinguishes discharge cells, and prevents ultraviolet rays and visible rays generated by the discharge from leaking to neighbor cells.

In an exemplary embodiment of the present invention, the barrier rib 21 can have various shaped structures as well as a structure shown in FIG. 1. For example, there are a differential type barrier rib structure, a channel type barrier rib structure, and a hollow type barrier rib structure. In the differential type barrier rib structure, the vertical barrier rib 21a and the horizontal barrier rib 21b are different in height. In the channel type barrier rib structure, a channel available for an exhaust passage is provided for at least one of the vertical barrier rib 21a and the horizontal barrier rib 21b. In the hollow type barrier rib structure, a hollow is provided for at least one of the vertical barrier rib 21a and the horizontal barrier rib 21b.

It is desirable that the horizontal barrier rib 21b is great in height in the differential type barrier rib structure. It is desirable that the horizontal barrier rib 21b has the channel or hollow in the channel type or hollow type barrier rib structure.

In an exemplary embodiment of the present invention, it is shown and described that each of Red (R), Green (G), and Blue (B) discharge cells is arranged on the same line. Alternatively, the R, G, and B discharge cells can be arranged in a different type. For example, there is a delta type arrangement where the R, G, and B discharge cells are arranged in a triangular shape. The discharge cell can have a rectangular shape as well as a polygonal shape such as a pentagonal shape and a hexagonal shape.

The respective phosphor layers 23 of the R, G, and B discharge cells can be of symmetric structure where they are substantially the same as each other or different from each other in pitch and width, or of asymmetric structure where they are different from each other in pitch. In case where the phosphors 23 are different from each other in pitch in the R, G, and B discharge cells, respectively, the phosphor layer 23 of the G or B discharge cell can be greater in pitch than the phosphor layer 23 of the R discharge cell.

The phosphor layer 23 is excited by the ultraviolet rays generated by the gas discharge, and emits any one visible ray among Red (R), Green (G), and Blue (B). An inertia mixture gas such as helium plus xenon (He+Xe), neon plus xenon (Ne+Xe), and helium plus neon plus xenon (He+Ne+Xe) is injected for the discharge into a discharge space provided between the front and lower substrates 10 and 20 and the barrier rib 21.

In the plasma display panel according to an exemplary embodiment of the present invention, the R, G, and B discharge cells can be substantially the same as each other in pitch. Alternately, the R, G, and B discharge cells can be different from each other in pitch to adjust color temperatures of the R, G, and B discharge cells. In this case, the pitches can be all different at the R, G, and B discharge cells, respectively. Alternatively, only the pitch of the discharge cell displaying one color among the R, G, and B discharge cells can be different. For example, the pitch of the R discharge cell can be the smallest, and the pitches of the G and B discharge cells can be greater than the pitch of the R discharge cell.

The address electrode 22 formed on the lower substrate 20 can be substantially constant in pitch or width within the discharge cell. Alternatively, the pitch or width within the discharge cell can be different from a pitch or width outside of the discharge cell. For example, the pitch or width within the discharge cell can be greater than that outside of the discharge cell.

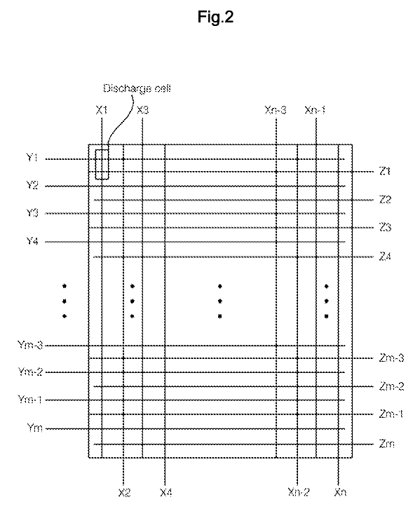

FIG. 2 is a diagram illustrating an electrode arrangement of the plasma display panel according to an exemplary embodiment of the present invention. It is desirable that a plurality of discharge cells constituting the plasma display panel are arranged in matrix form as shown in FIG. 2. In other words, scan electrode lines (Y1 to Ym) and sustain electrode lines (Z1 to Zm) are arranged at left/right sides of the panel. Address electrode lines (X1 to Xn) are arranged at up/down sides of the panel to intersect with the scan electrode lines (Y1 to Ym).

The plurality of discharge cells are provided at intersections of the scan electrode lines (Y1 to Ym) and the sustain electrode lines (Z1 to Zm), and the address electrode lines (X1 to Xn), respectively. The scan electrode lines (Y1 to Ym) can be driven sequentially or simultaneously. The sustain electrode lines (Z1 to Zm) can be driven simultaneously. The address electrode lines (X1 to Xn) can be divided into odd-numbered lines and even-numbered lines and driven, or can be driven sequentially.

The electrode arrangement of FIG. 2 is merely exemplary for the plasma display panel according to the present invention. Thus, the present invention is not limited to the electrode arrangement of the plasma display panel of FIG. 2 and a driving method thereof. For example, the present invention can also provide a dual scan method or a double scan method for simultaneously driving two ones among the scan electrode lines (Y1 to Ym). The dual scan method refers to a method for simultaneously driving two scan electrode lines belonging to respective upper and lower regions, by partitioning a plasma display panel as the two upper and lower regions. The double scan method refers to a method for simultaneously driving two scan electrode lines sequentially arranged.

A single scan method in which the two scan electrode lines are not simultaneously driven is desirable for the plasma display apparatus and the driving method of the panel according to the present invention.

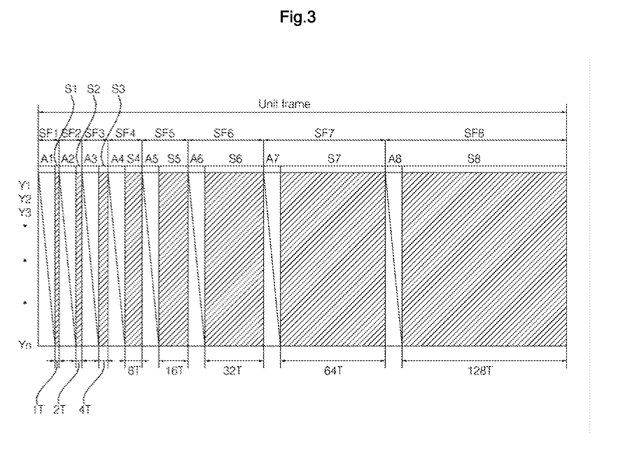

FIG. 3 is a diagram illustrating a method of time-division driving the plasma display apparatus by dividing one unit frame into a plurality of subfields according to an exemplary embodiment of the present invention. The unit frame can be divided into a predetermined number of subfields, e.g. eight subfields (SF1, . . . , SF8) to realize time-division gray level display. Each subfield (SF1, . . . , SF8) is divided into a reset period (not shown), an address period (A1, . . . , A8), and a sustain period (S1, . . . , S8).

In an exemplary embodiment of the present invention, the reset period can be omitted from at least one of the plurality of subfields. For example, the reset period can exist only at a first subfield, or can exist only at the first field and an approximately middle subfield among the whole subfield.

During each address period (A1, . . . , A8), an address signal is applied to the address electrode (X), and a scan signal associated with each scan electrode (Y) is sequentially applied to one scan electrode line one by one.

During each sustain period (S1, . . . , S8), a sustain signal is alternately applied to the scan electrode (Y) and the sustain electrode (Z), thereby inducing a sustain discharge in the discharge cell having wall charges formed in the address periods (A1, . . . , A8).

In the plasma display panel, luminance is proportional to the number of sustain discharge pulses within the sustain discharge periods (S1, . . . , S8) of the unit frame. In case where one frame constituting one image is expressed by 8 subfields and 256 gray levels, the sustain signals different from each other can be assigned to each subfield in a ratio of 1:2:4:8:16:32:64:128 in regular sequence. The cells are addressed and the sustain discharges are performed during the subfield1 (SF1), the subfield3 (SF3), and the subfield8 (SF8) so as to acquire luminance based on 133 gray levels.

The number of sustain discharges assigned to each subfield can be variably decided depending on subfield weights based on an Automatic Power Control (APC) level. In detail, the present invention is not limited to the exemplary description of FIG. 3 where one frame is divided into eight subfields, and can variously modify the number of subfields constituting one frame depending on a design specification. For example, one frame can be divided into 9 subfields or more like 12 subfields or 16 subfields to drive the plasma display panel.

The number of sustain discharges assigned to each subfield can be diversely modified considering a gamma characteristic or a panel characteristic. For example, a gray level assigned to the subfield4 (SF4) can decrease from 8 to 6, and a gray level assigned to the subfield6 (SF6) can increase from 32 to 34.

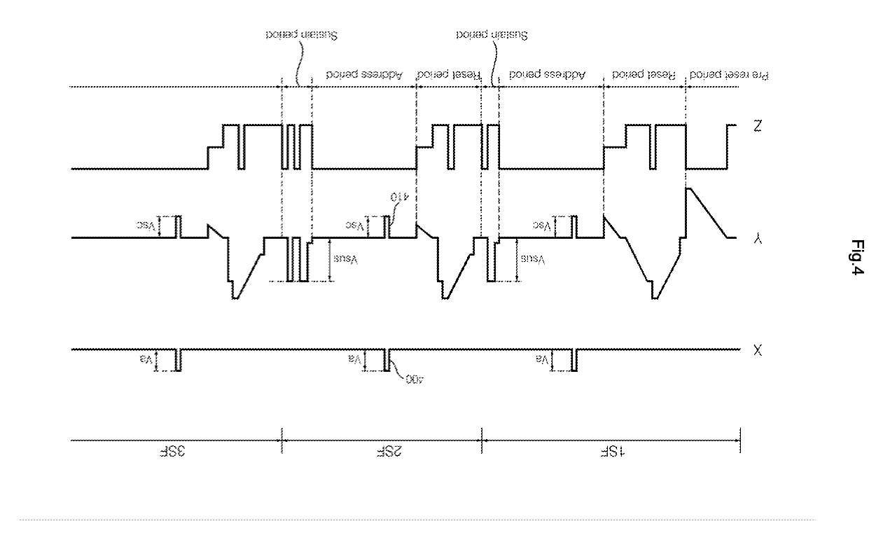

FIG. 4 is a timing diagram illustrating driving signals for driving the plasma display panel for one subfield according to an exemplary embodiment of the present invention.

The subfield includes a pre reset period for forming positive wall charges on the scan electrodes (Y) and forming negative wall charges on the sustain electrodes (Z); the reset period for initializing the discharge cells of a whole screen using a distribution of the wall charges formed during the pre reset period; the address period for selecting the discharge cell; and the sustain period for sustaining the discharge of the selected discharge cell.

The reset period is comprised of a setup period and a setdown period. During the setup period, a ramp-up waveform is concurrently applied to all the scan electrodes, thereby inducing a minute discharge in all the discharge cells and thus generating the wall charges. During the setdown period, a ramp-down waveform ramping down in a positive voltage lower than a peak voltage of the ramp-up waveform is concurrently applied to all the scan electrodes (Y), thereby inducing an erasure discharge in all the discharge cells and thus erasing unnecessary charges from space charges and the wall charges that are generated by the setup discharge.

During the address period, a scan signal 410 having a negative scan voltage (Vsc) is sequentially applied to the scan electrode (Y). An address signal 400 having a positive address voltage (Va) is applied to the address electrode (X) to superpose with the scan signal. A voltage difference between the scan signal 410 and the address signal 400, and a wall voltage generated during the reset period result in induction of an address discharge, thereby selecting the cell. During the setdown period and the address period, the signal sustaining a sustain voltage is applied to the sustain electrode.

During the sustain period, the sustain signal is alternately applied to the scan electrode and the sustain electrode, thereby inducing the sustain discharge between the scan electrode and the sustain electrode in a surface discharge type.

Driving waveforms of FIG. 4 are the driving signals for driving the plasma display panel according to an exemplary embodiment of the present invention, and are not intended to limit the scope of the present invention. For example, the pre reset period can be omitted. The driving signals of FIG. 4 can change in polarity and voltage level according to need. After the completion of the sustain discharge, an erasure signal for erasing the wall charges can be also applied to the sustain electrode. Single sustain driving is also possible in which the sustain signal is applied to only one of the scan electrode (Y) and the sustain electrode (Z), thereby inducing the sustain discharge.

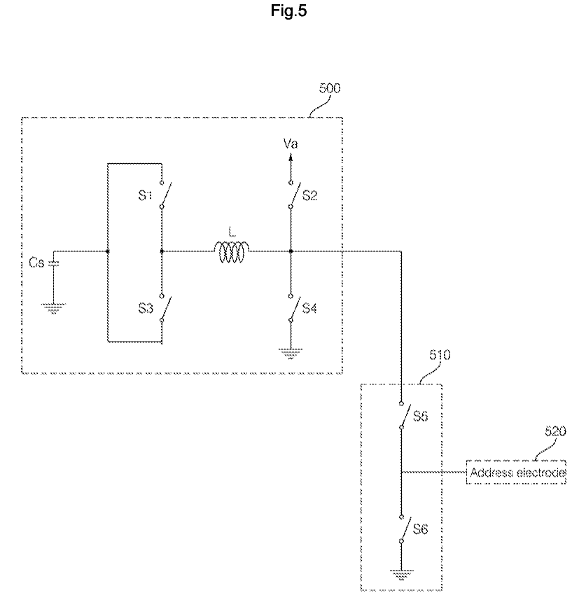

FIG. 5 is a circuit diagram illustrating a construction of an address driving circuit according to an exemplary embodiment of the present invention. The address driving circuit of FIG. 5 includes an energy recovery circuit 500, and a data Integrated Circuit (IC) 510.

The energy recovery circuit 500 includes a source capacitor (Cs) for recovering and storing energy supplied to an address electrode 520; a first switch (S1) turning on to supply the energy stored in the source capacitor (Cs) to the address electrode 520; a second switch (S2) turning on to recover the energy from the address electrode 520; an inductor (L) forming a resonance circuit together with a capacitance of the panel; an address voltage source (Va) for supplying an address voltage (Va); a third switch (S3) turning on to supply the address voltage (Va)(Vsus→Va) to the address electrode 520; and a fourth switch (S4) turning on so that the address voltage supplied to the address electrode 520 falls up to a ground voltage.

The data IC 510 includes a fifth switch (S5) turning on to supply an address signal to the address electrode 520; and a sixth switch (S6) turning on not to supply the address signal to the address electrode 520. In other words, the data IC 510 determines whether to supply the address signal to the address electrode 520 depending on input data.

A method for supplying the address signal in the above-constructed address driving circuit according to an exemplary embodiment of the present invention will be described with reference to FIG. 5.

In an energy supply period (ER_up), the first switch (S1) turns on, and the energy stored in the source capacitor (Cs) is supplied to the address electrode 520. Thus, a voltage supplied to the address electrode 520 gradually rises. In a sus-up period (SUS_up), the second switch (S2) turns on, and the voltage supplied to the address electrode 520 rises to the address voltage (Va).

It is desirable that the energy supply period (ER_up) is within a range of about 180 to 220( [symbol] ) to improve a luminance of a display image and simultaneously, enhance an energy efficiency.

In an energy recovery period (ER down), the third switch (S3) turns on, and the energy is recovered from the address electrode 520 to the source capacitor (Cs). Thus, the voltage supplied to the address electrode 520 gradually falls. In a sus-down period (SUS_down), the fourth switch (S4) turns on, and the voltage supplied to the address electrode 520 rapidly falls to the ground voltage.

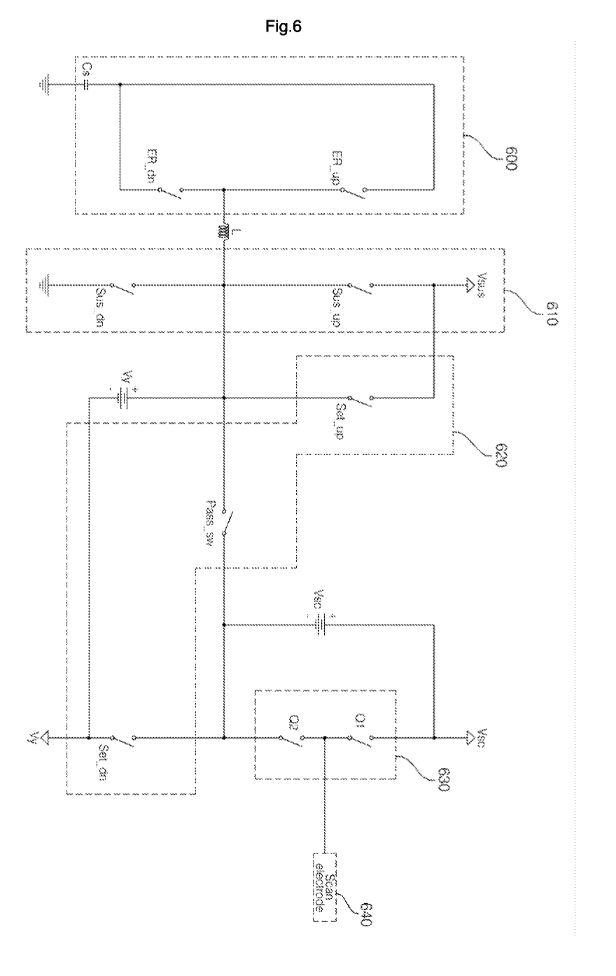

FIG. 6 is a circuit diagram illustrating a construction of a scan driving circuit according to an exemplary embodiment of the present invention. The scan driving circuit of FIG. 6 includes an energy recovery unit 600, a sustain driver 610, a reset driver 620, and a scan Integrated Circuit (IC) 630.

The sustain driver 610 includes a sustain voltage source (Vsus) for supplying a high electric potential sustain voltage (Vsus) during a sustain period; a sus-up switch (Sus_up) turning on to supply the sustain voltage (Vsus) to a scan electrode 640 (10→640); a sus-down switch (Sus_dn) turning on so that a voltage supplied to the scan electrode 640 falls to the ground voltage. In other words, in the sustain driver 610, the sus-up switch (Sus_up) connects with the sustain voltage (Vsus), and the sus-down switch (Sus_dn) connects with the sus-up switch (Sus_up) and the ground.

The energy recovery unit 600 includes a source capacitor (Cs) for recovering and storing energy supplied to the scan electrode 640; an energy supply switch (ER_up) turning on to supply the energy stored in the source capacitor (Cs) to the scan electrode 640; and an energy recovery switch (ER_dn) turning on to recover the energy from the scan electrode 640.

The reset driver 620 includes a set-up switch (Set_up) turning on to supply a setup signal, which gradually rises, to the scan electrode 640; a set-down switch (Set_dn) connecting with a negative voltage (−Vy), and turning on to supply a setdown signal, which gradually falls to the negative voltage (−Vy), to the scan electrode 640; and a pass switch (Pass_sw) forming a current pass path together with the scan electrode 640.

As shown in FIG. 6, the set-up switch (Set_up) has a drain connecting to the sustain voltage source, a source connecting to the pass switch (Pass_sw), and a gate connecting with a variable resistor (not shown). The set-up switch (Set_up) generates the setup signal that gradually rises depending on a resistance variation of the variable resistor.

The set-down switch (Set_dn) has a drain connecting to the scan IC 630, a source connecting to the negative voltage (−Vy), and a gate connecting with a variable resistor (not shown). The set-down switch (Set_dn) generates the setdown signal that gradually falls depending on a resistance variation of the variable resistor.

The scan IC 630 includes a scan-up switch (Q1) turning on to supply a scan voltage (Vsc) to the scan electrode 640, and connecting with a scan voltage source; and a scan-down switch (Q2) turning on to supply the ground voltage to the scan electrode 640.

In order to supply a scan signal to the scan electrode 640, the sus-down switch (Sus_dn), the pass switch (Pass_sw), and the scan-up switch (Q1) turn on, so that a voltage supplied to the scan electrode 640 rises to the scan voltage (Vsc). Also, the sus-down switch (Sus_dn), the pass switch (Pass_sw), and the scan-down switch (Q2) turn on, so that the voltage supplied to the scan electrode 640 falls to the ground voltage.

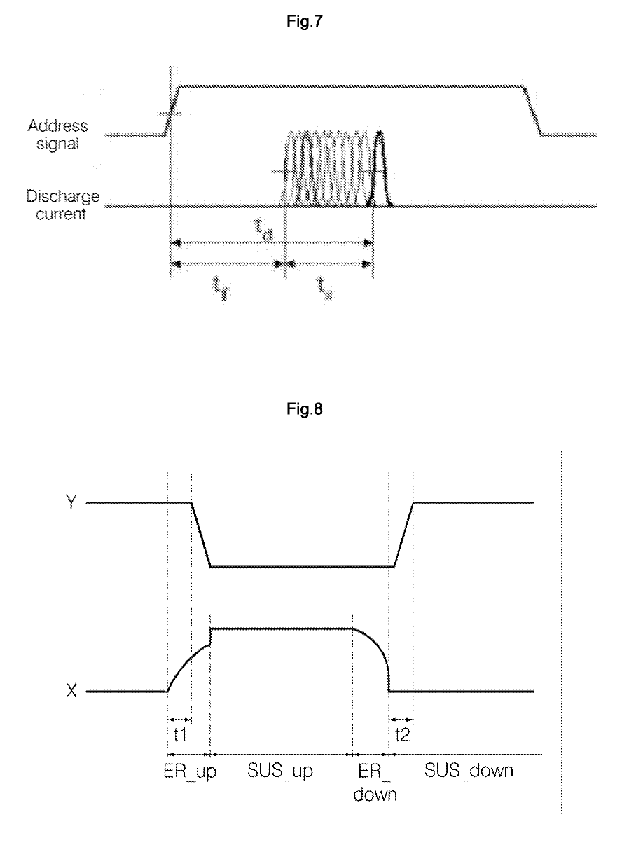

FIG. 7 is a diagram illustrating a discharge current depending on a discharge time lag occurring after the address signal is supplied.

As shown in FIG. 7, a discharge is lagged by the discharge time lag after the address signal is supplied to the address electrode. The discharge time lag is classified into a statistic time lag and a formative time lag. The formative time lag is caused by gas kind and pressure, a cell structure, and the secondary-electron emission efficiency of the protective film (MgO). The discharge time lag is a value obtained by adding the formative time lag to the statistic time lag. The formative time lag has a value of several hundreds of ns (nanoseconds). The statistic time lag has a value of several hundreds of ns (nanoseconds) to several μs (micro seconds).

In case where the address signal is generated using the energy recovery circuit, consumption power and heat emission at an address electrode side can reduce. However, as shown in FIG. 7, the discharge time lag can be greater.

FIG. 8 is a timing diagram illustrating supply time points for supplying the scan signal and the address signal according to the present invention.

Referring to FIG. 8, the address signal is supplied to the address electrode (X) earlier by a predetermined time (t1) than a time point where the scan signal starts to be supplied to the scan electrode (Y). As a supply time point of the address signal is moved up, the discharge time lag is moved up. Thus, a time taken to generate the address discharge after the supply start time point of the scan signal is shortened. So, a time required for addressing reduces.

It is desirable that the supply start time point of the scan signal precedes a start time point of the sus-up period (SUS_up) of the address signal.

The predetermined time (t1) for moving up the supply start time point of the address signal can be within a range of about 1 ns to a formative time lag time. Desirably, the predetermined time (t1) is within a range of about 1 ns to 500 ns. In case where the predetermined time (t1) for moving up the supply start time point of the address signal is within the above range, the scan voltage can be supplied after a time point for a discharge based on the address signal, thereby preventing occurrence of addressing error and inducing a stable address discharge.

The predetermined time (t1) for moving up the supply time point of the address signal can be within a range of about 20 ns to 200 ns, thereby improving a jitter characteristic effectively.

The address signal is supplied and terminated earlier by a predetermined time (t2) than a time point where the scan signal is supplied and terminated. The predetermined time (t2) for moving up a supply termination time point of the address signal can be within a range of about 1 ns to the formative time lag time. Desirably, the predetermined time (t2) is within a range of about 1 ns to 500 ns. A time duration of an address signal period does not vary to prevent an increase of power required for addressing. Thus, even the supply termination time point of the address signal is moved up as much as the supply start time point of the address signal is moved up.

The predetermined time (t2) for moving up the supply termination time point of the address signal can be within a range of about 20 to 200 ns, to effectively improve the jitter characteristic in driving the panel.

In an exemplary embodiment of the present invention, a difference between the supply start time points of the address signal and the scan signal and/or a difference between the termination start time points of the address signal and the scan signal is applicable to all the subfields or at least one subfield of one frame in the panel supplying the address signal using an energy recovery function.

In case where the scan signal varies in width in relation to a sequence of the subfield of one frame, even the address signal correspondingly varies in width while the difference between the supply start time points and/or the termination start time points is applicable to them. For example, in case where a width of the scan signal of a first subfield is the greatest, and a width of the scan signal of a last subfield is the smallest, the address signal is supplied and terminated earlier than the scan signal as described above while even the width of the address signal correspondingly to the width of the scan signal can reduce.

Alternatively, the supply start time point of the address signal is moved up while the termination start time point of the address signal can be also substantially matched with that of the scan signal in order to improve the discharge time lag. In this case, the width of the address signal is greater than the width of the scan signal within a range of about 1 ns to 500 ns.

In the above constructed plasma display apparatus according to the present invention, in case where the scan signal and the address signal are supplied to the plasma display panel to select the discharge cell using the address discharge based on a voltage difference between the scan signal and the address signal, the address signal can be supplied earlier than the scan signal, thereby moving up the time required for the discharge time lag, and reducing the time required for the addressing. The time required for the addressing can reduce, thereby sufficiently guaranteeing a driving margin required for single scan driving.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus including a plasma display panel having a plurality of scan electrode lines and address electrode lines, and supplying a scan signal to the scan electrode lines and supplying an address signal to the address electrode lines, the apparatus comprising:
an inductor forming a resonance circuit together with a capacitance of the panel,
whereby the address signal comprises a gradual rise or fall period, and
wherein a supply start time point of the address signal precedes a supply start time point of the scan signal.

2. The apparatus of claim 1, wherein the address signal comprises:
a rise period for gradually rising from a first voltage to a second voltage;
a sustain period for sustaining the second voltage; and
a fall period for gradually falling from the second voltage to a third voltage.

3. The apparatus of claim 1, wherein the scan signal is not simultaneously applied to two or more ones of the plurality of scan electrode lines.

4. The apparatus of claim 1, wherein the address electrode is not divided up/down.

5. The apparatus of claim 1, wherein the supply start time point of the address signal precedes the supply start time point of the scan signal by 1 ns to 500 ns.

6. The apparatus of claim 1, wherein the supply start time point of the address signal precedes the supply start time point of the scan signal by 20 ns to 200 ns.

7. The apparatus of claim 1, wherein the address signal has a rise period or fall period of 180 ns to 220 ns.

8. The apparatus of claim 2, wherein the supply start time point of the scan signal precedes a start time point of a sustain period of the address signal.

9. The apparatus of claim 1, wherein a supply termination time point of the address signal precedes a supply termination time point of the scan signal.

10. The apparatus of claim 9, wherein the supply termination time point of the address signal precedes the supply termination time point of the scan signal by 1 ns to 500 ns.

11. The apparatus of claim 9, wherein the supply termination time point of the address signal precedes the supply termination time point of the scan signal by 20 ns to 200 ns.

12. A plasma display apparatus including a plasma display panel having a plurality of scan electrode lines and address electrode lines, and supplying a scan signal to the scan electrode lines and supplying an address signal to the address electrode lines, the apparatus comprising:
a scan driver comprising:
a scan-up switch turning on to supply the scan signal having a scan voltage to the scan electrode line; and
a scan-down switch turning on to terminate a supply of the scan signal; and
an address driver comprising:
a source capacitor for storing energy recovered from the address electrode;
a first switch turning on to supply the energy stored in the source capacitor to the address electrode;
an inductor forming a resonance circuit together with a capacitance of the panel; and
a second switch turning on to recover the energy from the address electrode,
wherein the address signal comprises a gradual rise or fall period, and the first switch turns on earlier than the scan-up switch in an address period.

13. The apparatus of claim 12, wherein the first switch turns on earlier than the scan-up switch by 1 ns to 500 ns.

14. The apparatus of claim 12, wherein the first switch turns on earlier than the scan-up switch by 20 ns to 200 ns.

15. The apparatus of claim 12, wherein the second switch turns on earlier than the scan-down switch by 1 ns to 500 ns.

16. The apparatus of claim 12, wherein the second switch turns on earlier than the scan-down switch by 20 ns to 200 ns.

17. A method for driving a plasma display panel supplying a scan signal to a scan electrode line, and supplying an address signal to an address electrode line,
wherein the address signal comprising a gradual rise or fall period is supplied to the address electrode line using an inductor forming a resonance circuit together with a capacitance of the panel, and
wherein a supply start time point of the address signal precedes a supply start time point of the scan signal.

18. The method of claim 17, wherein the supply start time point of the address signal precedes the supply start time point of the scan signal by 1 ns to 500 ns.

19. The method of claim 17, wherein the supply start time of the address signal precedes the supply start time point of the scan signal by 20 ns to 200 ns.

20. The method of claim 17, wherein a supply termination time point of the address signal precedes a supply termination time point of the scan signal by 20 ns to 200 ns.
